(19) United States
(12) Patent Application Publication
(10) Pub. No.: US 2004/0123650 A1
(43) Pub. Date: Jul. 1, 2004

(54) High throughput rheological testing of materials

(75) Inventors: Oleg Kolosov, San Jose, CA (US); Leonid Matsiev, San Jose, CA (US)

Correspondence Address: DOBRUSIN & THENNISCH PC, 401 S OLD WOODWARD AVE, SUITE 311, BIRMINGHAM, MI, 48009, US

(73) Assignee: Symyx Technologies, Inc., Santa Clara, CA

(21) Appl. No.: 10/663,141

(22) Filed: Sep. 16, 2003

Related U.S. Application Data
(60) Provisional application No. 60/411,179, filed on Sep. 17, 2002.
(60) Provisional application No. 60/438,863, filed on Jan. 9, 2003.

(51) Int. Cl. G01N 11/14; G01N 11/00

(52) U.S. Cl. 73/54.28; 73/54.31; 73/54.33; 73/54.35; 73/54.01; 73/53.01

(57) ABSTRACT

The present invention provides systems and methods for screening a library of material samples for a rheological property such as viscosity or elasticity. Accordingly, a library of material samples is can be provided in a substantially liquid form. The library is contacted with at least one probe for applying a stimulus to the material samples such as by moving the at least one probe within the samples. A response such as resistance to the motion of the probe is monitored and can be related to a rheological property of the samples.

### CLAIM OF PRIORITY

The present invention claims the benefit of the priority of U.S. Provisional Application Serial No. 60/411,179, filed Sep. 17, 2002 and U.S. Provisional Application Serial No. 60/438,863, filed Jan. 9, 2003, the contents of both applications being incorporated herein by reference for all purposes.

### TECHNICAL FIELD

The present invention generally relates to the field of materials characterization. In particular, the invention relates to high throughput screens for evaluating the rheological properties of a material.

### BACKGROUND OF THE INVENTION

Currently, there is substantial research activity directed toward the discovery and optimization of polymeric materials for a wide range of applications. Although the chemistry of many polymers and polymerization reactions has been extensively studied, it is, nonetheless, rarely possible to predict a priori the physical or chemical properties a particular polymeric material will possess or the precise composition and architecture that will result from any particular synthesis scheme. Thus, characterization techniques to determine such properties are an essential part of the discovery process.

Combinatorial chemistry refers generally to methods for synthesizing a collection of chemically diverse materials and to methods for rapidly testing or screening this collection of materials for desirable performance characteristics and properties. Combinatorial chemistry approaches have greatly improved the efficiency of discovery of useful materials. For example, material scientists have developed and applied combinatorial chemistry approaches to discover a variety of novel materials, including for example, high temperature superconductors, magnetoresistors, phosphors and catalysts. See, for example, U.S. Pat. No. 5,776,359 to Schultz et al. In comparison to traditional materials science research, combinatorial materials research can effectively evaluate much larger numbers of diverse compounds in a much shorter period of time. Although such high-throughput synthesis and screening methodologies are conceptually promising, substantial technical challenges exist for application thereof to specific research and commercial goals.

With the development of combinatorial techniques that allow for the parallel synthesis of arrays comprising a vast number of diverse industrially relevant materials, there is a need for methods and devices and systems to rapidly characterize the physical and mechanical properties of the samples that are synthesized, such as the viscosity or related rheological properties of a material. There is also a particular need to reduce time involved in analyzing samples when transfer of the sample between locations is necessary. It would be especially attractive to rapidly test a plurality of samples on a common substrate, without needing to remove the samples from the substrate.

The characterization of materials using combinatorial methods has only recently become known. Examples of such technology are disclosed, for example, in commonly owned U.S. Pat. No. 6,182,499 (McFarland et al); U.S. Pat. No. 6,175,409 B1 (Nielsen et al); U.S. Pat. No. 6,157,449 (Hajduk et al); U.S. Pat. No. 6,151,123 (Nielsen); U.S. Pat. No. 6,034,775 (McFarland et al); U.S. Pat. No. 5,959,297 (Weinberg et al), all of which are hereby expressly incorporated by reference herein.

A high throughput viscometer is taught in U.S. application Ser. No. 09/578,997, filed May 25, 2000 (“High Throughput Viscometer and Method of Using the Same”) hereby expressly incorporated by reference herein. Additionally methods and systems for rheological testing are taught in U.S. patent application Ser. No. 09/939,149, filed Aug. 24, 2001 and titled, “High Throughput Rheological Testing of Materials” hereby expressly incorporated by reference herein.

### SUMMARY OF THE INVENTION

In accordance with one embodiment of the present invention, a library of materials is screened for rheological properties, such as viscosity or elasticity. Accordingly, one or more probes are contacted with a library of samples and more specifically a portion of the probes is submerged in the samples. The probes are moved (e.g., rotated in an oscillatory manner) relative to the samples and a parameter is monitored. The parameter can then be related to a rheological property such as viscosity or elasticity of the samples or a physical property, such as density. The invention can also be used for determining rheological properties of non-Newtonian fluids.

In another embodiment, a plurality of liquid samples is screened for a rheological property, where a library is provided having at least four different samples, and the rheological property of each of the samples is measured serially at a throughput rate no greater than about 10 minutes per sample.

In another embodiment, a plurality of liquid samples is screened for a rheological property, where a library is provided having at least four different samples, and the rheological property of at least two of the samples is measured simultaneously at a throughput rate no greater than about 10 minutes per library.

In another embodiment, there is disclosed another method of screening a library of materials for a rheological property. According to the method a library of material samples is supported in wells or on the surface of one or more substrates. Each sample is at least partially contacted with a contact portion of one or more probes. The contact portion of the one or more probes is moved (e.g., rotated) relative to the each sample of the library of samples. Moreover, a parameter selected from power or force used to move the one or more probes or position amplitude, phase or position time dependence of the one or more probes is monitored during the moving of the contact portion of the one or more probes. Furthermore, the parameter is related to a rheological property of the each sample of the library of samples.

In more specific embodiments, for example, the library can include at least 16 material samples supported in wells or on the surface of a substrate. As another example the contact portion of the one or more probes is move in an oscillatory manner relative to the each sample of the library of samples according to electrical signals produced by a waveform generator. As another example, the contacting step can include attaching one or more actuators to an automated system and at least selectively attaching the one or more probes to the automated system such that the automated system can moves the one or more actuators and the one or more probes for contacting the each sample of the library of samples with the contact portion of the one or more probes. In still another example, the contact portion of the one or more probes can be rotated according to electrical signals produced by a waveform generator that is at least selectively in electrical communication with the one or more actuators;

In yet another embodiment, there is disclosed a system for screening a library of materials for a rheological property. The system includes a plurality of samples supported in wells or on a surface of a substrate, the plurality of samples being fluidic. The system also includes one or more probes, each of the one or more probes including a contact portion for at least partially contacting the plurality of samples. An actuator can be included for rotating the contact portion of the one or more probes in an oscillatory manner relative to the plurality of samples. A transducer can also be included for sensing a parameter selected from torque used to rotate the one or more probes or rate of rotation of the one or more probes wherein the parameter can be related to the rheological property of the plurality of samples. Moreover, the system can include an automated system for moving the one or more probes relative to the plurality of samples.

### BRIEF DESCRIPTION OF THE DRAWINGS

FIG. 1 is a schematic of a system in accordance with the present invention.

FIGS. 2A-2D are perspective view of exemplary probes, which may be employed in accordance with the present invention.

FIG. 3 illustrates a system in accordance with the present invention.

FIGS. 3A-3F illustrates various portions or aspects of the system of FIG.3.

FIGS. 4A-4B Illustrate graphs of data produced by a system in accordance with the present invention.

### DETAILED DESCRIPTION OF THE INVENTION

I. Glossary

The following terms are intended to have the following general meanings as they are used herein.

1. Substrate: A material or structure having a rigid or semi rigid surface. In many embodiments, the substrate will have physically separate regions for different materials with, for example, dimples, wells, trenches, or the like. The regions will typically be no greater than about 1 liter, and more specifically will be smaller than about 0.1 liter, more specifically smaller than about 0.01 liter and still more specifically smaller than about 0.001 liter. One substrate useful in accordance with the present invention is a microtiter plate having a plurality of wells, and the plurality of wells may include at least 8×N wells, where N is an integer 1 or higher. Another substrate useful in accordance with the present invention is a vial rack supporting a plurality of vials.

2. Viscosity: A measure of a resistance of a fluid to flow when subjected to a force, which induces a shear stress. Reference herein to viscosity is not intended to exclude the employment of viscosity measurements to determine other properties recognized as interdependent upon the measurement of viscosity, including, but not limited to, density, temperature dependent properties of materials, pressure dependent properties of material, velocity/flowrate dependent properties of materials or the like.

These and other aspects of the invention are to be considered exemplary and non-limiting, and are discussed in greater detail below. The several aspects of the characterization methods and systems disclosed and claimed herein can be advantageously employed separately, or in combination to efficiently characterize a variety of materials, with particular emphasis on polymeric materials. In certain embodiments, these features are employed in combination to form a materials characterization system that can operate as a high-throughput screen in a materials science research program directed to identifying, characterizing or optimizing new or existing materials. Certain characterizing information—particularly those obtainable from the present invention are broadly useful for characterizing polymers and polymerization reactions. As such, the particular materials and/or mechanisms disclosed herein should be considered exemplary of the invention and non-limiting as to the scope of the invention, which may be applicable in a variety of applications.

### Combinatorial Approaches for Research

In a combinatorial approach for identifying or optimizing materials or preparation conditions, a large compositional space (e.g., with respect to polymers, of monomers, comonomers, catalysts, catalyst precursors, solvents, initiators, additives, or of relative ratios of two or more of the aforementioned) and/or a large reaction condition space (e.g., of temperature, pressure and reaction time) may be rapidly explored by preparing libraries and then rapidly screening such libraries. By way of illustration, polymer libraries can comprise, for example, polymerization product mixtures resulting from polymerization reactions that are varied with respect to such factors.

Combinatorial approaches for screening a library can include an initial, primary screening, in which product mixtures are rapidly evaluated to provide valuable preliminary data and, optimally, to identify several “hits”—particular candidate materials having characteristics that meet or exceed certain predetermined metrics (e.g., performance characteristics, desirable properties, unexpected and/or unusual properties, etc.). Such metrics may be defined, for example, by the characteristics of a known or standard material or preparation scheme. Because local performance maxima may exist in compositional spaces between those evaluated in the primary screening of the first libraries or alternatively, in process-condition spaces different from those considered in the first screening, it may be advantageous to screen more focused libraries (e.g., libraries focused on a smaller range of compositional gradients, or libraries comprising compounds having incrementally smaller structural variations relative to those of the identified hits) and additionally or alternatively, subject the initial hits to variations in process conditions. Hence, a primary screen can be used reiteratively to explore localized and/or optimized compositional space in greater detail. The preparation and evaluation of more focused libraries can continue as long as the high-throughput primary screen can meaningfully distinguish between neighboring library compositions or compounds.

Once one or more hits have been satisfactorily identified based on the primary screening, libraries focused around the primary-screen hits can be evaluated with a secondary screen—a screen designed to provide (and typically verified, based on known materials, to provide) chemical process conditions that relate with a greater degree of confidence to commercially-important processes and conditions than those applied in the primary screen. In many situations, such improved “real-world-modeling” considerations are incorporated into the secondary screen at the expense of methodology speed (e.g., as measured by sample throughput) compared to a corresponding primary screen. Particular compositions, reactants, additives, processing conditions or post-synthesis processing conditions having characteristics that surpass the predetermined metrics for the secondary screen may then be considered to be “leads.” If desired, additional libraries focused about such lead materials can be screened with additional secondary screens or with tertiary screens. Identified lead compositions, reactants, additives, processing conditions or post-synthesis processing conditions may be subsequently developed for commercial applications through traditional bench-scale and/or pilot scale experiments.

While the concept of primary screens and secondary screens as outlined above provides a valuable combinatorial research model, a secondary screen may not be necessary for certain chemical processes where primary screens provide an adequate level of confidence as to scalability and/or where market conditions warrant a direct development approach. Similarly, where optimization of materials having known properties of interest is desired, it may be appropriate to start with a secondary screen. In general, the systems, devices and methods of the present invention may be applied as either a primary, secondary or other screen, depending on the specific research program and goals thereof. See, generally, U.S. patent application Ser. No. 09/227,558 entitled “Apparatus and Method of Research for Creating and Testing Novel Catalysts, Reactions and Polymers”, filed Jan. 8, 1999 by Turner et al., for further discussion of a combinatorial approach to polymer science research.

According to the present invention, methods, systems and devices are disclosed that improve the efficiency and/or effectiveness of the steps necessary to characterize mechanical or physical properties of a single sample or a plurality of samples (e.g., libraries of samples). In certain embodiments, a property of a plurality of samples or of components thereof can be analyzed in a characterization system with an average sample-throughput sufficient for an effective combinatorial science research program.

In accordance with one embodiment of the present invention, an array of materials is screened for viscosity. An array of materials is provided. The array is contacted with at least one capillary for permitting the materials to be drawn into the capillary. A first force is applied to the materials while present in the capillary. The relative flow resistance of the materials in the capillary is measured in response to the force; and the materials in the library of materials are ranked or otherwise compared with each other or another material based on the monitored flow resistance.

Various protocols may be employed involving some or all of the aforementioned steps. For example, a sample may be analyzed either with preparation or without preparation. Additionally it should be recognized that sequences other than the order of steps listed above are possible, and the above listing is not intended as limiting.

As a general approach for improving the sample throughput for a plurality of samples (e.g., polymer samples), each of the steps applicable to a given characterization protocol can be optimized with respect to time and quality of information, both individually and in combination with each other. Additionally or alternatively, each or some of such steps can be effected in a rapid-serial, parallel, serial-parallel or hybrid parallel-serial manner.

The throughput of a plurality of samples through a single step in a characterization process is improved by optimizing the speed of that step, while maintaining—to the extent necessary—the information-quality aspects of that step. Although conventional research norms, developed in the context in which research was rate-limited primarily by the synthesis of samples, may find such an approach less than wholly satisfactory, the degree of rigor can be entirely satisfactory for a primary or a secondary screen of a combinatorial library of samples. For combinatorial research (and as well, for many on-line process control systems), the quality of information should be sufficiently rigorous to provide for scientifically acceptable distinctions between the compounds or process conditions being investigated, and for a secondary screen, to provide for scientifically acceptable correlation (e.g., values or, for some cases, trends) with more rigorous, albeit more laborious and time-consuming traditional characterization approaches.

The throughput of a plurality of samples through a series of steps, where such steps are repeated for the plurality of samples, can also be optimized. In one approach, one or more steps of the cycle can be compressed relative to traditional approaches or can have leading or lagging aspects truncated to allow other steps of the same cycle to occur sooner compared to the cycle with traditional approaches. In another approach, the earlier steps of a second cycle can be performed concurrently with the later steps of a first cycle. For example, in a rapid-serial approach for characterizing a sample, sample delivery to a substrate for a second sample in a series can be effected before or while the first sample in the series is being screened. As another example, a screen of a second sample in a series can be initiated while the first sample in the series is being screened. These approaches, as well as others, are discussed in greater detail below.

A characterization protocol for a plurality of samples can involve a single-step process (e.g., direct measurement of a property of a sample or of a component thereof). In a rapid-serial screen approach for a single-step process, the plurality of samples and a single measuring instrument or other apparatus are serially positioned in relation to each other for serial analysis of the samples. In a parallel detection approach, two or more measuring instruments or other apparatus are employed to measure a property of two or more samples simultaneously.

In a serial-parallel approach, a property of a larger number of samples (e.g., four or more) is screened as follows. First, a property of a subset of the four or more samples (e.g., 2 samples) is screened in parallel for the subset of samples, and then serially thereafter, the same property of another subset of four or more samples is screened in parallel. It will be recognized, of course, that plural measuring instruments can be employed simultaneous, or plural measuring instruments can be employed serially.

For characterization protocols involving more than one step, optimization approaches to effect high-throughput characterization can vary. As one example, a plurality of samples can be characterized with a single characterization system (I) in a rapid-serial approach in which each of the plurality of samples (s₁, s₂, s₃ . . . sₙ) are processed serially through the characterization system (I) with each of the steps effected in series on each of the of samples to produce a serial stream of corresponding characterizing property information (p₁, p₂, p₃ . . . pₙ). This approach benefits from minimal capital investment, and may provide sufficient throughput—particularly when the steps have been optimized with respect to speed and quality of information.

As another example, a plurality of samples can be characterized with two or more instruments in a pure parallel (or for larger libraries, serial-parallel) approach in which the plurality of samples (s₁, s₂, s₃ . . . sₙ) or a subset thereof are processed through the two or more measurement systems (I, II, III . . . N) in parallel, with each individual system effecting each step on one of the samples to produce the property information (p₁, p₂, p₃ . . . pₙ) in parallel. This approach is advantageous with respect to overall throughput, but may be constrained by the required capital investment.

In a hybrid approach, certain of the steps of the characterization process can be effected in parallel, while certain other steps can be effected in series. For example, it may be desirable to effect the longer, throughput-limiting steps in parallel for the plurality of samples, while effecting the faster, less limiting steps in series. Such a parallel-series hybrid approach can be exemplified by parallel sample preparation of a plurality of samples (s₁, s₂, s₃ . . . sₙ), followed by measuring a property with a single apparatus to produce a serial stream of corresponding characterizing property information (p₁, p₂, p₃ pₙ). In another exemplary parallel-series hybrid approach, a plurality of samples (s₁, s₂, s₃ . . . sₙ) are prepared, measured and correlated in a slightly offset (staggered) parallel manner to produce the characterizing property information (p₁, p₂, p₃ . . . pₙ) in the same staggered-parallel manner.

Optimization of individual characterization steps with respect to speed and quality of information can improve sample throughput regardless of whether the overall characterization scheme involves a rapid-serial or parallel aspect (i.e., true parallel, serial-parallel or hybrid parallel-series approaches). As such, the optimization techniques disclosed hereinafter, while discussed primarily in the context of a rapid-serial approach, are not limited to such an approach, and will have application to schemes involving parallel characterization protocols.

Material Samples

The materials screened in the present invention include polymeric materials, organic materials, amorphous materials, crystalline materials, macromolecular materials, small-molecule materials, inorganic materials, pure materials, mixtures of materials or the like.

The present invention may be used to screen or test most any flowable material that may be a commercial product itself or may be an ingredient or portion within a commercial product. Exemplary commercial products, which may be tested or may include ingredients that may be tested according to the present invention include pharmaceuticals, coatings, cosmetics, adhesives, inks, foods, crop agents, detergents, protective agents, lubricants and the like. Polyelectrolytes or polyampholytes may also be screened.

In a one particular embodiment, the present invention is employed for screening flowable samples. The invention thus has particular utility in connection with the screening of a number of different material forms including, for example, gels, oils, solvents, greases, creams, foams and other whipped materials, ointments, pastes, powders, films, particles, bulk materials, dispersions, suspensions, emulsions or the like. The invention can be used to analyze the resulting properties of a particular flowable sample material or the relative or comparative effects that an additive or environmental condition has upon a particular flowable sample material (e.g., the effect of a detergent, a flow modifier, or the like).

In another particular embodiment, the present invention is employed for screening polymer samples, or plastic samples including polymers. Accordingly, unless otherwise stated, reference to screening of polymers or other processing of polymers includes plastics incorporating such polymers. The polymer sample can be a homogeneous polymer sample or a heterogeneous polymer sample, and in either case, comprises one or more polymer components. As used herein, the term “polymer component” refers to a sample component that includes one or more polymer molecules. The polymer molecules in a particular polymer component have the same repeat unit, and can be structurally identical to each other or structurally different from each other. For example, a polymer component may comprise a number of different molecules, with each molecule having the same repeat unit, but with a number of molecules having different molecular weights from each other (e.g., due to a different degree of polymerization). As another example, a heterogeneous mixture of copolymer molecules may, in some cases, be included within a single polymer component (e.g., a copolymer with a regularly-occurring repeat unit), or may, in other cases, define two or more different polymer components (e.g., a copolymer with irregularly-occurring or randomly-occurring repeat units). Hence, different polymer components include polymer molecules having different repeat units. It is possible that a particular polymer sample (e.g., a member of a library) will not contain a particular polymer molecule or polymer component of interest. Blends of polymers may also be analyzed in accordance with the present invention.

In one embodiment, the polymer molecule of the polymer component is a non-biological polymer, though biological polymers may also be screened in accordance with the present invention. A non-biological polymer is, for purposes herein, a polymer other than an amino-acid polymer (e.g., protein) or a nucleic acid polymer (e.g., deoxyribonucleic acid (DNA)). Though the employment of the present invention for screening of materials for use as biological implants is contemplated. The non-biological polymer molecule of the polymer component is, however, not generally critical; that is, the systems and methods disclosed herein will have broad application with respect to the type (e.g., architecture, composition, synthesis method or mechanism) and/or nature (e.g., physical state, form, attributes) of the non-biological polymer. Hence, the polymer molecule can be, with respect to homopolymer or copolymer architecture, a linear polymer, a branched polymer (e.g., short-chain branched, long-chained branched, hyper-branched), a cross-linked polymer, a cyclic polymer or a dendritic polymer. A copolymer molecule can be a random copolymer molecule, a block copolymer molecule (e.g., di-block, tri-block, multi-block, taper-block), a graft copolymer molecule or a comb copolymer molecule.

The particular composition of the polymer molecule is not critical, the material may be thermoplastic, thermoset or a mixture thereof. It may be a polycondensate, polyadduct, a modified natural polymer, or otherwise. Exemplary materials include polymers incorporating olefins, styrenes, acrylates, methacrylates, polyimides, polyamides, epoxies, silicones, phenolics, rubbers, halogenated polymers, polycarbonates, polyketones, urethanes, polyesters, silanes, sulfones, allyls, polyphenylene oxides, terphthalates, or mixtures thereof. Other specific illustrative examples can include repeat units or random occurrences of one or more of the following, without limitation: polyethylene, polypropylene, polystyrene, polyolefin, polyamide, polyimide, polyisobutylene, polyacrylonitrile, poly(vinyl chloride), poly(methyl methacrylate), poly(vinyl acetate), poly(vinylidene chloride), polytetrafluoroethylene, polyisoprene, polyacrylamide, polyacrylic acid, polyacrylate, poly(ethylene oxide), poly(ethyleneimine), polyamide, polyester, polyurethane, polysiloxane, polyether, polyphosphazine, polymethacrylate, and polyacetals. Polysaccharides are also included within the scope of polymers. Exemplary naturally-occurring polysaccharides include cellulose, dextran, gums (e.g., guar gum, locust bean gum, tamarind xyloglucan, pullulan), and other naturally-occurring biomass. Exemplary semi-synthetic polysaccharides having industrial applications include cellulose diacetate, cellulose triacetate, acylated cellulose, carboxymethyl cellulose and hydroxypropyl cellulose. In any case, such naturally-occurring and semi-synthetic polysaccharides can be modified by reactions such as hydrolysis, esterification, alkylation, or by other reactions.

In typical applications, a polymer sample is a heterogeneous sample comprising one or more polymer components, one or more monomer components and/or and an additional phase which may be a continuous fluid phase. In copolymer applications, the polymer sample can comprise one or more copolymers, a first comonomer, a second comonomer, additional comonomers, and/or a continuous fluid phase. The polymer samples can, in any case, also include other components, such as catalysts, catalyst precursors (e.g., ligands, metal-precursors), solvents, initiators, additives, products of undesired side-reactions (e.g., polymer gel, or undesired homopolymer or copolymers) and/or impurities. Typical additives include, for example, surfactants, fillers, reinforcements, flame retardants, colorants, environmental protectants, other performance modifiers, control agents, plasticizers, cosolvents and/or accelerators, among others. In th is regard, the present invention is particularly attractive for the screening of affects of variations of additives upon the characteristics of the material. The various components of the heterogeneous polymer sample can be uniformly or non-uniformly dispersed in the continuous fluid phase.

In one embodiment, useful in connection with the screening of polymers, at a point prior to, during, or after depositing the sample onto the substrate, the sample is treated to form a flowable sample, such as a polymer solution, a polymer emulsion, a polymer dispersion or a polymer that is liquid in the pure state (i.e., a neat polymer), or a melt. A polymer solution comprises one or more polymer components dissolved in a solvent. The polymer solution can be of a form that includes well-dissolved chains and/or dissolved aggregated micelles. The solvent can vary, depending on the application, for example with respect to polarity, volatility, stability, and/or inertness or reactivity. Typical solvents include, for example, tetrahydrofuran (THF), toluene, hexane, ethers, trichlorobenzene, dichlorobenzene, dimethylformamide, water, aqueous buffers, alcohols, etc. According to traditional chemistry conventions, a polymer emulsion can be considered to comprise one or more liquid-phase polymer components emulsified (uniformly or non-uniformly) in a liquid continuous phase, and a polymer dispersion can be considered to comprise solid particles of one or more polymer components dispersed (uniformly or non-uniformly) in a liquid continuous phase. The polymer emulsion and the polymer dispersion can also be considered, however, to have the more typically employed meanings specific to the art of polymer science—of being an emulsion-polymerization product and dispersion-polymerization product, respectively. In such cases, for example, the emulsion polymer sample can more generally include one or more polymer components that are insoluble, but uniformly dispersed, in a continuous phase, with typical emulsions including polymer component particles ranging in diameter from about 1 nm to about 500 nm, more typically from about 5 nm to about 300 nm, and even more typically from about 40 nm to about 200 nm. The dispersion polymer sample can, in such cases, generally include polymer component particles that are dispersed (uniformly or nonuniformly) in a continuous phase, with typical particles having a diameter ranging from about 0.2 un to about 1000 um, more typically from about 0.4 un to about 500 um, and even more typically from about 0.5 um to about 200 um. Exemplary polymers that can be in the form of neat polymer samples include dendrimers, and siloxane, among others. The liquid polymer sample can also be employed in the form of a slurry, a latex, a microgel a physical gel, or in any other form sufficient for creating an array for screening analysis as described and claimed herein. In some cases, polymer synthesis reactions (i.e., polymerizations) directly produce liquid samples. These may be bulk liquid polymers, polymer solutions, or heterogeneous liquid samples such as polymer emulsions, latices, or dispersions. In other cases, the polymer may be synthesized, stored or otherwise available for characterization in a non-liquid physical state, such as a solid state (e.g., crystalline, semicrystalline or amorphous), a glassy state or rubbery state. Hence, the polymer sample may need to be dissolved, dispersed or emulsified to form a liquid sample by addition of a continuous liquid-phase such as a solvent. The polymer sample can, regardless of its particular form, have various attributes, including variations with respect to polarity, solubility and/or miscibility.

In some applications, the polymer sample is a polymerization product mixture. As used herein, the term “polymerization product mixture” refers to a mixture of sample components obtained as a product from a polymerization reaction. An exemplary polymerization product mixture can be a sample from a combinatorial library prepared by polymerization reactions, or can be a polymer sample drawn off of an industrial process line. In general, the polymer sample may be obtained after the synthesis reaction is stopped or completed or during the course of the polymerization reaction. Alternatively, samples of each polymerization reaction can be taken and placed into an intermediate array of vessels at various times during the course of the synthesis, optionally with addition of more solvent or other reagents to arrest the synthesis reaction or prepare the samples for analysis. These intermediate arrays can then be characterized at any time without interrupting the synthesis reaction. It is also possible to use polymer samples or libraries of polymer samples that were prepared previously and stored. Typically, polymer libraries can be stored with agents to ensure polymer integrity. Such storage agents include, for example, antioxidants or other agents effective for preventing cross-linking of polymer molecules during storage. Depending upon the polymerization reaction, other processing steps may also be desired, all of which may be automated. The polymerization scheme and/or mechanism by which the polymer molecules of the polymer component of the sample are prepared is not critical, and can include, for example, reactions considered to be addition polymerization, condensation polymerization, step-growth polymerization, and/or chain-growth polymerization reactions. Viewed from another aspect, the polymerization reaction can be an emulsion polymerization or a dispersion polymerization reaction. Viewed more specifically with respect to the mechanism, the polymerization reaction can be radical polymerization, ionic polymerization (e.g., cationic polymerization, anionic polymerization), and/or ring-opening polymerization reactions, among others. Non-limiting examples of the foregoing include, Ziegler-Natta or Kaminsky-Sinn reactions and various copolymerization reactions. Polymerization product mixtures can also be prepared by modification of a polymeric starting materials, by grafting reactions, chain extension, chain scission, functional group interconversion, or other reactions.

It will be appreciated that in certain embodiments, a polymer sample is formed in situ on a substrate, post synthesis treated in situ on a substrate, or a combination thereof. Examples of such post synthesis treatment steps include for instance, heat treating, environmental exposure (e.g. temperature moisture, radiation, chemicals, etc.), aged, or the like.

Sample Size

The sample size is not narrowly critical, and can generally vary, depending on the particular characterization protocols and systems used to analyze the sample or components thereof. However, it will be appreciated that the present invention advantageously permits for attaining reliable data with relatively small samples. Typical sample sizes can range from about 0.1 microgram to about 1 gram, more typically from about 1 microgram to about 1000 micrograms, even more typically from about 5 micrograms to about 100 micrograms, and still more typically from about 20 micrograms to about 50 micrograms.

When placed on a substrate for forming an array, as discussed herein with regard to sampling, the samples may be dispensed with any suitable dispensing apparatus (e.g. an automated micropipette or capillary dispenser, which may include a heated tip). Each sample of the array is dispensed to an individually addressable region on the substrate. Typically each sample occupies no more than about 1000 mm², more specifically no more than about 100 mm², more specifically no more than about 20 mm² of planar area on a substrate surface, more specifically no more than about 5 mm², and shall more specifically occupy no more than about 0.5 mm². Of course, larger areas are contemplated as well. In applications where the sample is disposed in a well, the sample size typically does not exceed about 20 milligrams, but it may be heavier if desired.

Accordingly, for some applications, the individual samples are each typically no greater than about 20 ml, more typically no greater than about 5 ml and still more typically no greater than about 0.5 ml, although the sample may be larger if desired.

Libraries of Samples

While, the apparatus and methods of the present invention may be employed in conjunction with a single sample, they are often advantageously employed for a plurality of samples. A plurality of samples comprises 2 or more samples that are physically or temporally separated from each other—for example, by residing in different regions of a substrate, in different sample containers, by having a membrane or other partitioning material positioned between samples, or otherwise. The plurality of samples typically comprises 4 or more samples and more typically 8 or more samples, although there may be greater or fewer samples as well. Four samples can be employed, for example, in connection with experiments having one control sample and three samples varying (e.g., with respect to composition or process conditions as discussed above) to be representative of a high, a medium and a low-value of the varied factor—and thereby, to provide some indication as to trends. Four samples are also a minimum number of samples to effect a serial-parallel characterization approach, as described above (e.g., with two detectors operating in parallel). Eight samples can provide for additional variations in the explored factor space. Moreover, eight samples corresponds to the number of parallel polymerization reactors in the PPR-₈™, being selectively offered as one of the Discovery ToolS™ of Symyx Technologies, Inc. (Santa Clara, Calif.), which can be used to prepare polymers for screening in accordance with the present invention. Higher numbers of samples can be investigated, according to the methods of the invention, to provide additional insights into larger compositional and/or process space. In some cases, for example, the plurality of samples can be 15 or more samples, 20 or more samples, 40 or more samples and even 80 or more samples. Such numbers can be loosely associated with standard configurations of other parallel reactor configurations for synthesizing polymers for screening herein (e.g., the PPR-48™, Symyx Technologies, Inc.) and/or of standard sample containers (e.g., 96-well microtiter plate-type formats). Moreover, even larger numbers of samples can be characterized according to the methods of the present invention for larger scale research endeavors. Hence, the number of samples can be 150 or more, 400 or more, 500 or more, 750 or more, 1,000 or more, 1,500 or more, 2,000 or more, 5,000 or more and 10,000 or more samples. As such, the number of samples can range from about 2 samples to about 10,000 samples, but more typically will range from about 8 samples to about 10,000 samples. In many applications, however, the number of samples can range from about 80 samples to about 1500 samples. In some cases, in which processing of samples using typical 96-well microtiter-plate formatting is convenient or otherwise desirable, the number of polymer samples can be 96*N, where N is an integer ranging from about 1 to about 100. For many applications, N can suitably range from 1 to about 20, and in some cases, from 1 to about 5.

The plurality of samples can be a library of samples. A library of samples comprises an array of two or more different samples spatially separated—for example, on a common substrate, or temporally separated. Candidate samples (i.e., members) within a library may differ in a definable and typically predefined way, including with regard to chemical structure, processing (e.g., synthesis) history, mixtures of interacting components, post-synthesis treatment, purity, etc. The samples may be spatially separated at an exposed surface of the substrate, such that the array of samples are separately addressable for characterization thereof. The two or more different samples can reside in sample containers formed as wells in a surface of the substrate or upon a surface (e.g., a common planar surface) of a substrate. The number of samples included within the library can generally be the same as the number of samples included within the plurality of samples, as discussed above. In general, however, not all of the samples within a library of samples need to be different samples. When process conditions are to be evaluated, the libraries may contain only one type of sample. Typically, however, for combinatorial chemistry research applications, at least two or more, at least four or more, or even eight or more and, in many cases most, and allowably each of the plurality of samples in a given library of samples will be different from each other. Specifically, a different sample can be included within at least about 50%, within at least 75%, within at least 80%, within at least 90%, within at least 95%, within at least 98% and even within at least 99% of the samples included in the sample library. In some cases, all of the samples in a library of samples will be different from each other.

In one embodiment, at least eight samples are provided in a library on a substrate and at least about 50% of the samples included in the library are different from each other. In another embodiment, the library includes at least 16 samples and at least 75% of the samples included in the library are different from each other. In still another embodiment, the library includes at least 48 samples and at least 90% of the samples included in the library are different from each other.

The substrate can be a structure having a rigid or semi-rigid surface on which or into which the array of samples can be formed or deposited. The substrate can be of any suitable material, and can include materials that are inert with respect to the polymer samples of interest, or otherwise will not materially affect the mechanical or physical characteristics of one sample in an array relative to another. Exemplary polymeric materials that can be suitable as a substrate material in particular applications include polyimides such as Kapton, polypropylene, polytetrafluoroethylene (PTFE) and/or polyether etherketone (PEEK), among others. The substrate material can also be selected for suitability in connection with known fabrication techniques. Stainless steel or another metal, or ceramics such as silicon including polycrystalline silicon, single-crystal silicon, sputtered silicon, and silica (SiO₂) in any of its forms (quartz, glass, etc.) are suitable substrate materials. Other known materials (e.g., silicon nitride, silicon carbide, metal oxides (e.g., alumina), mixed metal oxides, metal halides (e.g., magnesium chloride), minerals, zeolites, and ceramics) may also be suitable for a substrate material in some applications. As to form, the sample containers formed in, at or on a substrate can be, but are not necessarily, arranged in a substantially flat, substantially planar surface of the substrate. The sample containers can be formed in a surface of the substrate as dimples, spots, wells, raised regions, trenches, or the like. Non-conventional substrate-based sample containers, such as relatively flat surfaces having surface-modified regions (e.g., selectively wettable regions) can also be employed. The overall size and/or shape of the substrate is not limiting to the invention. The size and shape can be chosen, however, to be compatible with commercial availability, existing fabrication techniques, and/or with known or later-developed automation techniques, including automated sampling and automated substrate-handling devices. The substrate can also be sized to be portable by humans. The substrate can be thermally insulated, particularly for high-temperature and/or low-temperature applications.

In some embodiments, the substrate is designed such that the individually addressable regions of the substrate can act as polymerization or other suitable reaction vessels for preparing a product mixture, as well as sample containers for the in-situ analysis of two or more different samples during subsequent characterization thereof. Glass-lined, 96-well, 384-well and 1536-well microtiter-type plates, fabricated from stainless steel and/or aluminum, are some substrates for a library of liquid or polymer samples. The choice of an appropriate specific substrate material and/or form for certain applications will be apparent to those of skill in the art in view of the guidance provided herein.

The library of materials can be a combinatorial library of product mixtures. Libraries can comprise, for example, product mixtures resulting from reactions that are varied with respect to, for example, reactant materials (e.g., monomers, comonomers), catalysts, catalyst precursors, initiators, additives, the relative amounts of such components, reaction conditions (e.g., temperature, pressure, reaction time), post-synthesis treatment, or any other factor affecting polymerization or material properties. Design variables for polymerization reactions are well known in the art. See generally, Odian, Principles of Polymerization, 3rd Ed., John Wiley & Sons, Inc. (1991). A library of polymer samples may be prepared in arrays, in parallel polymerization reactors or in a serial fashion. Exemplary methods and apparatus for preparing polymer libraries—based on combinatorial polymer synthesis approaches—are disclosed in copending U.S. patent application Ser. No. 09/211,982 of Turner et al. filed Dec. 14, 1998, copending U.S. patent application Ser. No. 09/227,558 of Turner et al. filed Jan. 8, 1999, copending U.S. patent application Ser. No. 09/235,368 of Weinberg et al. filed Jan. 21, 1999, and copending U.S. provisional patent application Ser. No. 60/122,704 entitled “Controlled, Stable Free Radical Emulsion and Water-Based Polymerizations”, filed Mar. 9, 1999 by Klaerner et al. See also, PCT Pat. Application WO 96/11878.

The libraries can be advantageously characterized directly, without being isolated, from the reaction vessel in which the sample was prepared or synthesized.

While such methods may be employed for a combinatorial approach to research, they are to be considered exemplary and non-limiting. As noted above, the particular samples characterized according to the methods and with the apparatus disclosed herein can be from any source, including, but not limited to polymerization product mixtures or other liquids, including those resulting from combinatorial synthesis approaches.

Analytical Instrument

The protocols for characterizing one or more samples can further comprise determining a property of interest from responses of the samples to a stimulus. The responses can be correlated to properties of interest. Such properties of interest include, without limitation, rheological properties such as viscosity, viscoelasticity (e.g., shear dependent viscoelasticity), shear thinning, shear thickening, yield, stress and the like. Other properties of interest may include, without limitation, density, melt index, thermal degradation, aging characteristics, weight-average molecular weight, number-average molecular weight, viscosity-average molecular weight, peak molecular weight, approximate molecular weight, polydispersity index, molecular-weight-distribution shape, relative or absolute component concentration, chemical composition, conversion, concentration, mass, hydrodynamic radius, radius of gyration, chemical composition, amounts of residual monomer, presence and amounts of other low-molecular weight impurities in samples, particle or molecular size, intrinsic viscosity, molecular shape, molecular conformation, and/or agglomeration or assemblage of molecules. The correlation between a measured response and a determined property of interest can be based on mathematical models and/or empirical calibrations. Such correlation methods are generally known in the art.

The aforementioned characterizing properties of interest can, once determined, be mathematically combined in various combinations to provide figures of merit for various properties or attributes of interest. Other combinations of the fundamental characterization properties of interest will be apparent to those of skill in the art.

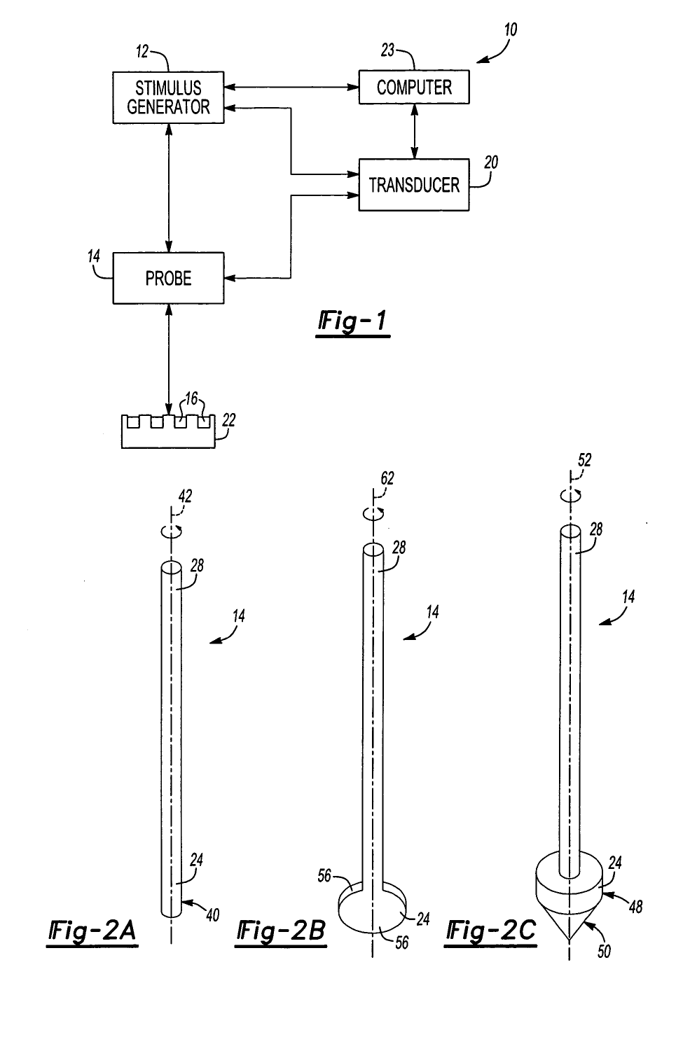

Referring to FIG. 1, there is illustrated a schematic system 10 for measuring or determining material properties such as viscosity, rheology, elasticity or the like of a combinatorial library of material samples. The system 10 of the present invention will typically include a stimulus generator 12 that applies power to a probe 14 for applying a stimulus (e.g., a force such as torque) to one or more samples 16 in an array or library of samples 16. The system 10 will also typically include a sensor or transducer 20 for monitoring a response (e.g., resistance) of the one or more samples 16 to the stimulus. Often, the samples 16 are supported by one or more substrates 22, although not necessarily required.

Generally, for determining properties of the samples 16, at least a portion of the probe 14 is contacted with a sample 16 and the stimulus generator 12 typically moves the portion of the probe 14 while the transducer 20 monitors the response of the sample 16. In turn, the response of the sample 16 is directly or indirectly correlated to a property of the sample 16. Typically, the transducer 20, the stimulus generator 12 or both are in communication with a computer sub-system 23 such as a microprocessor or other like computer for manipulating data. For example, the computer sub-system 23 may be employed to receive and store data such as responses of samples 16, material properties of samples 16 or the like. Additionally, the computer sub-system 23 may be employed to command other components (e.g., the stimulus generator) of the system 10 or to correlate responses of samples 16 to their respective material properties.

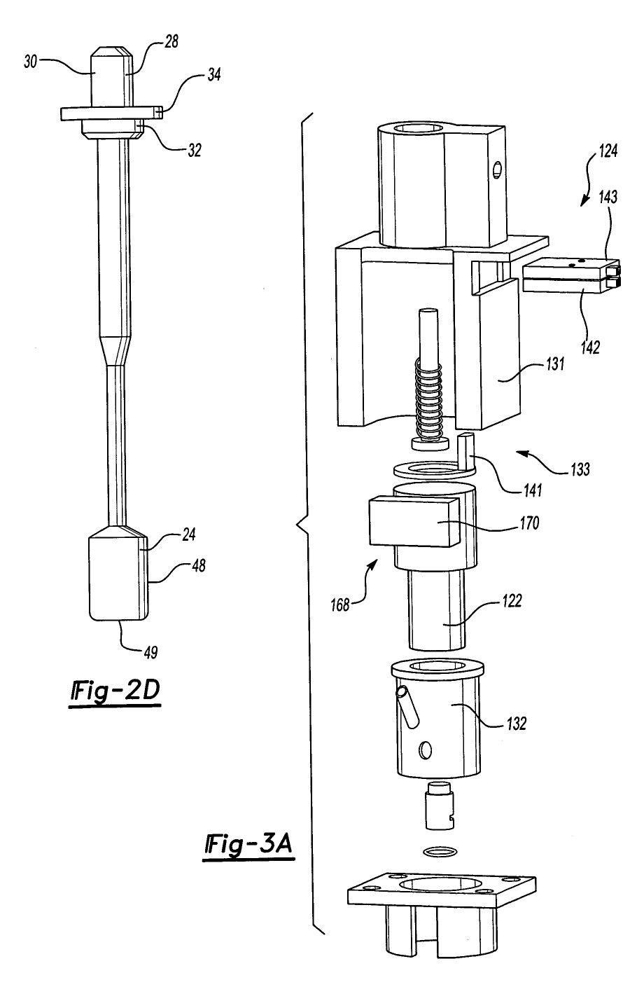

The probe 14 of the system 10 may be supplied in a variety of configurations depending upon the properties of the samples 16 to be measured, the type of samples 16 being screened or the like. The probe can be made of any suitable material such as metal, plastic or ceramic material, and may be coated or uncoated over some or all of its surface that is to contact the samples. Moreover, the probe 14 may be coated or uncoated, smooth or roughened or otherwise treated for modifying its surface characteristics over some or all of its inner or outer surfaces. Additionally referring to FIGS. 2A-2D, the probes 14 of the present invention can provide a contact portion 24 for contacting the samples 16 and an attachment portion 28 for connecting the contact portion 24 to the stimulus generator 12. Although, attachment portions may be provided in a variety of configurations, one exemplary attachment portion 28 is illustrated in FIG. 2D to include a first cylindrical portion 30, a second cylindrical portion 32 and a disc-shaped portion 34 disposed therebetween.

It is contemplated that that the probe 14 may be contacted with samples 16 and moved relative to the samples according to a variety of protocols. For example, the probe 14 may be contacted with a sample 16 either partially, fully, continuously, intermittently, a combination thereof or the like. For movement of the probes 14 relative to the samples 16, for example, the probe 14 may be translated, rotated, reciprocated, oscillated combinations thereof or the like for subjecting the sample 16 to a variety of forces such as compressive, tensile, or shear forces. In one embodiment, the contact portion 24 of the probe 14 is substantially submerged within the sample 16 and is moved (e.g., rotated either continuously or in an oscillatory fashion) in a manner that creates a force (e.g., a shear force, tensile force, compressive force or combination thereof) upon the sample 16. For example, the contact portion 24 of the probe 14 may be rotated, moved back and forth or a combination thereof in a reciprocating or oscillatory manner within and relative to the sample 16.

In an alternative embodiment, a probe may be moved according to a predetermined motion (e.g., rotated a predetermined number (3600) of degrees, translated a predetermined distance or the like) while contacting each sample. In such an embodiment, it may be desirable to monitor the response (e.g., resistance to movement) of the samples over a time period during the predetermined motion such that changes in the response can be evaluated over the time period. Advantageously, such motion and response monitoring can assist in evaluating different samples (e.g., samples that plastically deform).

Depending upon the motion of the probe 14 relative to the samples 16, the type of samples 16 to be tested or the like, it may be desirable to have a particular shape or configuration for the contact portion 24 of the probe 14. For movement of the contact portion 24 within a sample where the sample has a relatively higher viscosity, it may be desirable to employ contact portions 24 having surfaces that are substantially curved (e.g., about an axis) for the probe 14. As one example, the probe 14 of FIG. 2A includes a contact portion 24 with an outer cylindrical surface 40 substantially surrounding, extending or curving about an axis 42 of rotation of the probe 14 for lessening the force applied by the probe. As another example, the probe 14 of FIG. 2C includes a contact portion 24 with an outer cylindrical surface 48 and outer conical surface 50, both of which substantially extend or curve about an axis 52 of rotation of the probe 14. As still another example, the probe 14 of FIG. 2D includes a contact portion 24 with an outer cylindrical surface 48 as in FIG. 2C, but which ends at a circular planar surface 49. Advantageously, such curved surfaces allow for easier rotation of the probes in more viscous solutions. For movement of the contact portion 24 within a sample where the sample has a relatively lower viscosity, it may be desirable to employ contact portions 24 having surfaces that are substantially planar or linear for the probe 14 for increasing the force applied by the probe. For example, FIG. 2B includes a disc-shaped contact portion 24 with a plurality of contact surfaces 56 that are substantially linear and/or planar relative to an axis 62 of rotation of the probe 14. Advantageously, such linear or planar surfaces may provide greater forces on lower viscosity samples.

For contacting the probe 14 with the samples 16, the samples 16 may be moved relative to the probe 14, the stimulus generator 12 or both. Alternatively, the probe 14, the stimulus generator or both may be moved relative to the samples 16. As another alternative, combinations of these motions may occur serially or simultaneously. According to one exemplary embodiment, an automated system may be used to move one or more probes serially or simultaneously to the various samples of a library. According to another exemplary embodiment, the stimulus generator 12 may be stationary (e.g., mounted on a holder or frame (not shown)) along with one or more probes such that samples may be moved by an automated system (e.g., a robot arm) or a manual system for contacting the one or more of the samples with the one or more of the probes.

By way of example, a suitable automated system may be a robotic system such as an XYZ robot arm available commercially from suppliers such as Tecan Systems, Inc. (San Jose, Calif.). Such device has multiple axis range of motion such as a range of motion in the orthogonal x, y, z coordinate axes system. Typically, such an automated system would be part of or in communication with the computer sub-system 23.

For moving the probe 14 during contacting of each sample 16 of the library, the stimulus generator 12 can include a power source. It is contemplated that the power source could be electrical, mechanical, manual a combination thereof or the like and may be operated by the computer sub-system 23 although not required. As examples, the power source could include one or more motors such as one or more suitable stepper motors or servo motors.

One exemplary stimulus generator includes a motor that employs a moving magnetic actuator coupled with a suitable position detector. For example, the motor may be a closed loop galvanometer. Other technologies are also possible, such as devices that employ a moving coil, or devices that employ an LED position detector, a capacitive detector, or combinations thereof. A typical working frequency range for such a motor will be about 0.001 Hz to about 2500 Hz, and more specifically about 5 Hz to about 1500 Hz and even more specifically 10 Hz to about 1000 Hz. A typical step response for the motor ranges from about 10 to about 1000 microseconds and more specifically is on the order of about 100 microseconds. The motor may be employed in combination with one or more suitable scanning mirrors, x-y mounts, servo drivers, software or the like. One particular motor suitable for use in the present invention is available commercially from Cambridge Technologies under the 62xx series of galvanometers. A typical motor will exhibit like characteristics as the devices in that series within a range of about +/−25% of the published performance data for such devices.

According to one embodiment of the present invention, the stimulus generator includes a stimulus control unit, which may be configured to assist in controlling the amount of power or force required to move the probe 14 relative to the sample 16. When the power source is an electric motor, it may be desirable for the stimulus control unit to include circuitry capable of controlling the electricity sent to the motor and, in turn, be capable of controlling the power or force applied to or applied by the probe 14.

The transducer 20 of the present invention may be chosen from several different devices, for example, a sensing device such as a motion sensor, a load sensor, a speed or rate sensor, a force sensor, a power sensor, an electrical sensor or the like. Moreover, the transducer 20 may sense a variety of system parameters such as motion of the samples 16, properties of the samples 16, resistance of the samples 16 to motion of the probe 14, rate of motion of the probe 14 within a sample 16, amplitude or phase of the probe 14, power or force required to move the probe 14 within a sample 16 or the like for determining or measuring responses and/or properties of samples 16. For embodiments having probes that are rotated within a sample, the transducer may sense either the motion (e.g. the rotation rate, the oscillation rate, phase or amplitude, a combination thereof or the like) of the probe 14 or the sway (e.g., power, electrical energy, force, torque or the like) used to rotate a probe 14 within a sample 16.

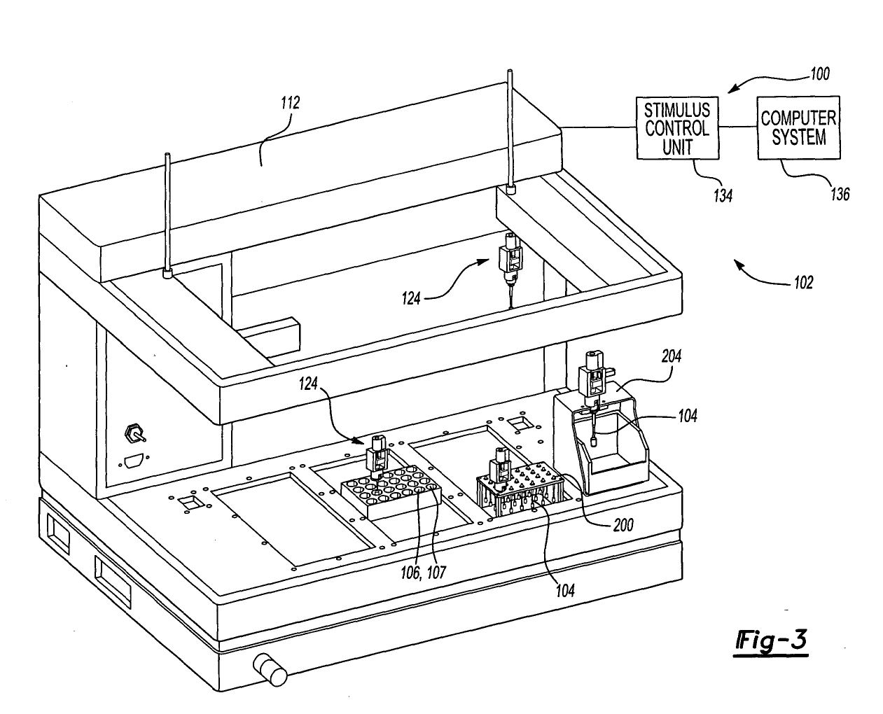

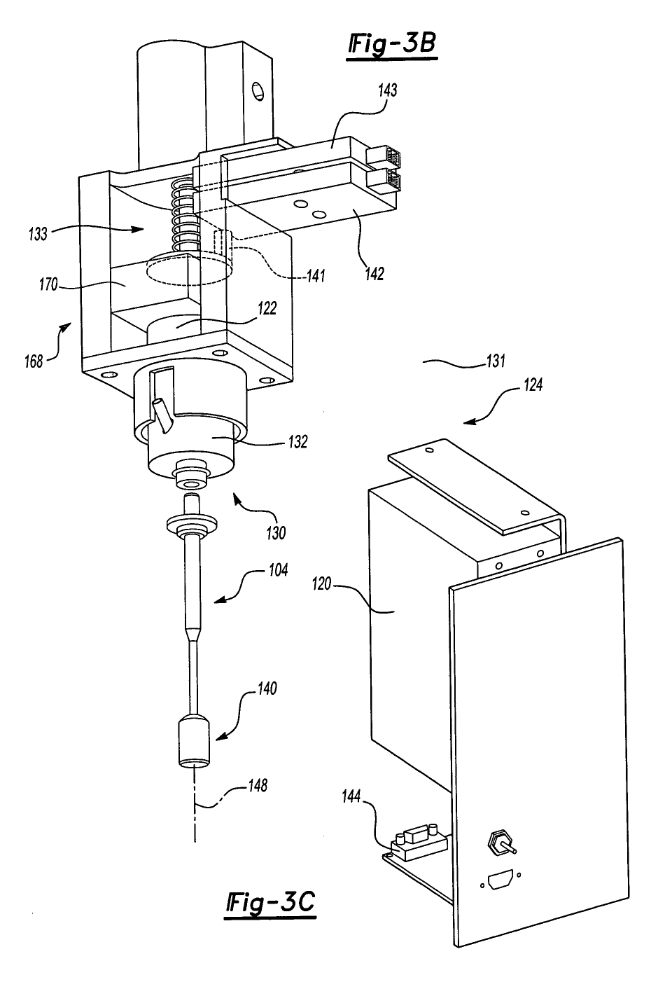

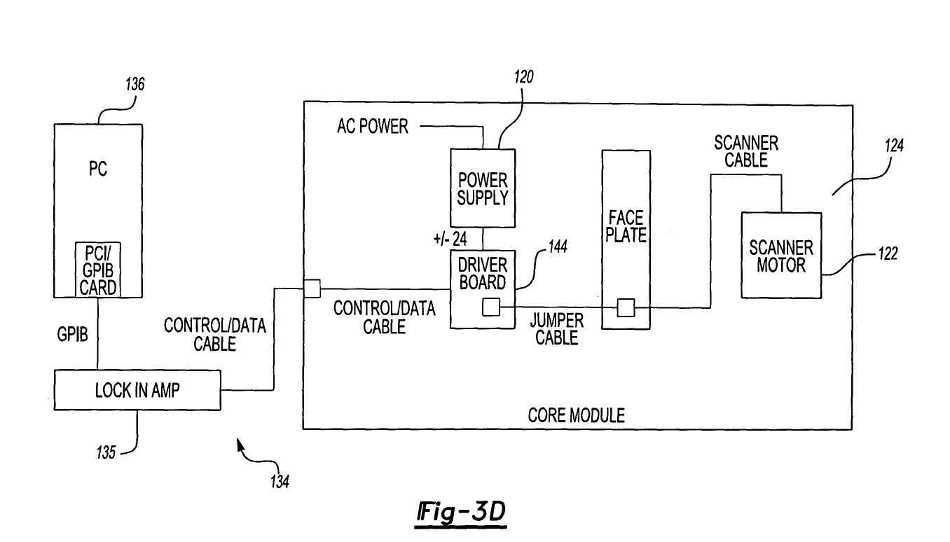

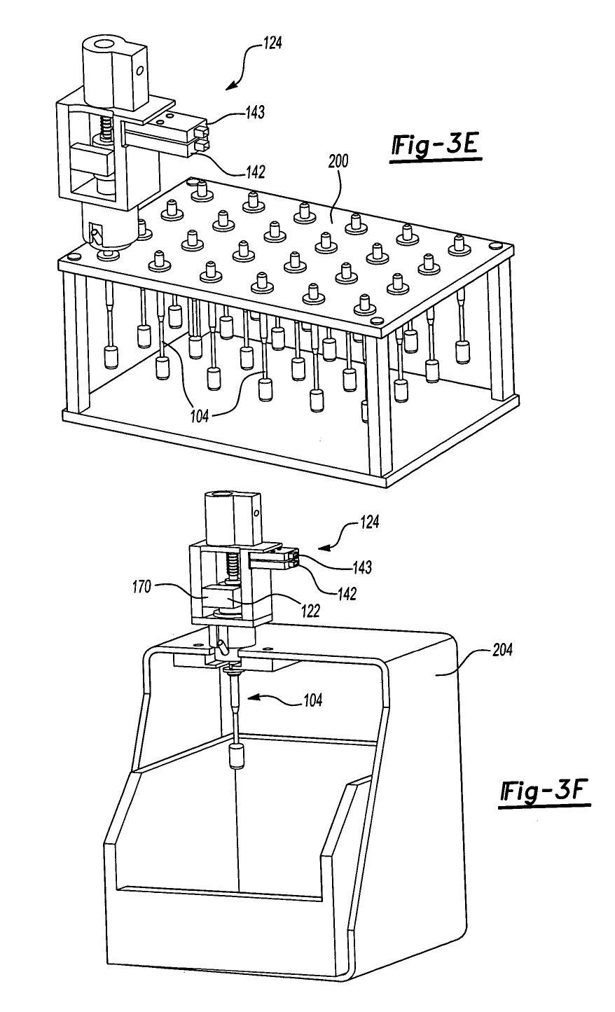

Referring to FIGS. 3-3F, there is illustrated one example of a specific system 100 for determining properties of material samples in accordance with the present invention. It should be appreciated that the specific system 100 in FIG. 3-3F should not limit any particular aspect or element of the present invention unless a claim specifically recites details of such aspect or element.

In FIGS. 3-3F, the system 100 illustrated includes a stimulus generator 102 employing one or more probes 104 for providing a stimulus to samples 106 in wells or vessels 107 of one or more substrates 108 (e.g., shown as a single common substrate). The system 100 typically includes an automated apparatus 112 shown as a robot arm for moving the one or more probes 104 to and from the samples 106.

The stimulus generator 102 includes a power source 120 and one or more actuators 124 (e.g., a rotary actuator) that includes a motor 122 (e.g., a servo drive or scan motor) for moving (e.g., rotating, oscillating, both rotating and oscillating or the like) the probe 104. As shown, the probe 104 is attached to the actuator 124 via a fastener 130 (e.g., a chuck, an adapter or the like). In the particular embodiment shown, the actuator(s) 124 also include a housing 131 and a sleeve 132 for at least partially housing the motor 122. The stimulus generator 102 may also include an absorption mechanism 133 (e.g., a plunger/spring assembly) for providing cushion to the probe 14 and to the automated apparatus 112.

The stimulus generator 102 also includes a stimulus control unit 134 in communication with the power source 120 for controlling the rate of movement (e.g., rate of rotational motion, oscillatory motion, amplitude, phase, rotational/oscillatory motion or the like) of the probe 104. In the embodiment shown, the stimulus control unit 134 includes circuitry 135, and more particularly, includes a lock-in amplifier. Typically, the system 100 includes a computer sub-system 136 for inputting, outputting, manipulating or the like data such as responses of the samples 106.

In operation, a contact portion 140 (e.g., a paddle or cylindrical shaped contact portion) of the probe 104 is immersed in a sample 106. This can be accomplished by the automated apparatus 112 moving the probe 104 to the sample 106 and immersing the contact portion 140 into the sample 106.

For assisting in controlling immersion (e.g., rate or depth of immersion), one or more sensors may be may be included in the system 100 in signaling communication with the computer system, the automated apparatus or both. In the embodiment illustrated, a moveable member 141 and a pair of stacked sensors 142, 143 are employed for assisting in determining if the contact portion 140 of the probe 104 unintentionally or otherwise contacts a solid entity (e.g., a vessel or solidified sample) during immersion. In particular, contact between a solid entity and the contact portion 104 will typically translate the moveable member 141 upward such that the member 141 is sensed by the lower sensor 142. The lower sensor 142 then signals contact with a solidified sample 106 or other solid entity. If the member 141 continues to translate upwardly, the member 141 is then sensed by the upper sensor, which signals the automated apparatus to discontinue further immersion thereby avoiding potential damage to the system 100.

During and/or after immersion, at least the contact portion 140 of the probe 104 is moved within the sample 106 in an oscillatory manner. For effecting the oscillatory motion, a waveform generator 144 may be employed as part of, or in communication (e.g., electrical communication) with the stimulus generator 102, the motor 122 of the generator 102, the power supply of the generator 102 or a combination thereof. In such a configuration, the motor 122 can input the electrical signals (e.g., electrical sine or cosine waves) and can output force (e.g., torque) upon the probe 104 in correspondence with those electrical signals thereby causing the probe 104 to move (e.g., rotate in an oscillatory manner about an axis 148 of rotation) within the sample.

During the movement of the probe 104 in the sample 106, a response of the sample 106 is typically monitored. Although it is contemplated that a variety of responses may be monitored as previously discussed, in the embodiment of FIG. 3, the response at least relates to the resistance of the sample to the force (e.g., torque) placed on the sample by the movement of the probe 104. In turn, such resistance can be related to rheological properties of the sample 106 such as viscosity, elasticity or the like.

Accordingly, in one mebodiment for monitoring a response of the sample, it may be desirable to monitor the movement of the probe 104 (e.g., amplitude and/or phase) for a particular power or force supplied by the motor 122 or it may be desirable to monitor the amount of power or force supplied by the motor 122 for a particular and constant rate of movement, such as phase and amplitude. For monitoring the rate of movement of the probe 104, the motor 122 can supply a substantially constant force or forces and the transducer 168 may be a motion sensor 170 (e.g., an angle sensor) sensing the angular position of the probe 104, which, in turn, can be related to the rate of movement (e.g., oscillatory motion, such as amplitude and phase) of the probe 104.

Alternatively, in one embodiment for monitoring the power or force (e.g., torque) supplied by the motor 122, the probe 104 can be brought to a predetermined constant rate of motion (e.g., oscillatory rotationa t a set amplitude and phase) and the transducer may be a force sensing device (e.g., a feedback mechanism of the motor 122) that monitors the amount of power or forcesupplied to or by the motor 122 to achieve the rate of motion. In the embodiment illustrated in FIG. 3, the system 100 can achieve the predetermined motion (oscillatory amplitude and phase) by placing the motor 122 and the motion sensor 170 in communication with the stimulus control unit 134. In turn, the stimulus control unit 134 can determine the rate of motion from the motion sensor 170 and can adjust the amount of power or force supplied by the motor 122 such that the predetermined c motion is achieved.

For monitoring responses from the entire library of samples 106, the probe 104 may optionally be replaced by other probes 104 or the probe 104 may be cleaned and the new probes 104 or the same probe 104 may be contacted with subsequent samples 106 of the library and a response for each of the subsequent samples 106 may be attained according to the technique described above. In the particular embodiment depicted, the system 100 includes a plurality of disposable probes 104 supported upon a probe rack 200 and a disposal assembly 204 for receiving used probes 104. In operation, the automated apparatus 112 moves one or more actuators 124 to and/or from the probe rack 200 for retrieving a probe 104. Thereafter, the apparatus 112 moves the probe 104 to the substrate 108 for immersing the probe 104 in one of the samples 106 and for stimulating the samples 106 as described above. Then, the automated apparatus 112 moves the actuator 124 and the probe 104 to the disposal assembly 204 where the probe 104 is removed from the actuator 124 such that a new probe 104 may be retrieved to repeat the steps above.

Although the system 100 in FIG. 3 is shown with the stimulus generator 102 operating a single probe 104 at one time to stimulate samples 106 in a serial manner, it is contemplated that one or more stimulus generators 102 and/or one or more actuators 124 may operate one or more probes 104 simultaneously or in parallel for stimulating multiple samples 106 in a parallel fashion.

During or after monitoring of the responses of the samples to the motion of the probes, it may be desirable for the responses to be related to a material property (e.g., a rheological property such as viscosity or elasticity). This relation between the responses and the material properties may be determined according to a variety of techniques. According to one embodiment, the system of the present invention may be calibrated for determining material properties of the samples. In such an embodiment, a plurality of control samples having known material properties are monitored for responses to the motion of the probe of the system wherein the responses are dependent upon the known material properties of the control samples. Then, the responses are related to the known material properties of the control samples to form a mathematical relationship between responses of material samples and the material properties. Thus, when responses of the a library of material samples such as the library of samples 16 of FIG. 1 are monitored, they can be related to the material properties by the mathematical relationship.

As an example of one particular calibration, reference is made to the system 100 of FIG. 3 being calibrated such that the system 100 may be used to determine viscosities of a library of material samples 106. In the particular system 100, several control samples (not shown) of known viscosities may be monitored as described above for responses to the motion (e.g., oscillatory rotation) of the probe 104. In turn, a mathematical relationship may be derived (e.g., curve fit) that relates the responses of the control samples to their respective viscosities. Thereafter, the responses of the samples 106 of unknown viscosity may also be monitored as described above and the viscosities of the samples 106 may be determined by relating the responses of the samples 106 to their viscosities via the mathematical relationship. Advantageously, it has been found that within certain ranges, the mathematical relationship between the responses of the samples and the material properties of the samples is substantially linear.

For storage and/or manipulation of data such as the responses of samples, the material properties of samples, combinations thereof or the like, it may be desirable for the data to be received within one of the computer sub-systems 23, 136. Generally, it is contemplated that various types of data manipulation may be accomplished using a variety of computer programs and also that various visual representations of such data may be provided such as graphs or the like. One example of a commercially available software is marketed under the tradename EPOCH™, available from Symyx Technoloies, Inc.

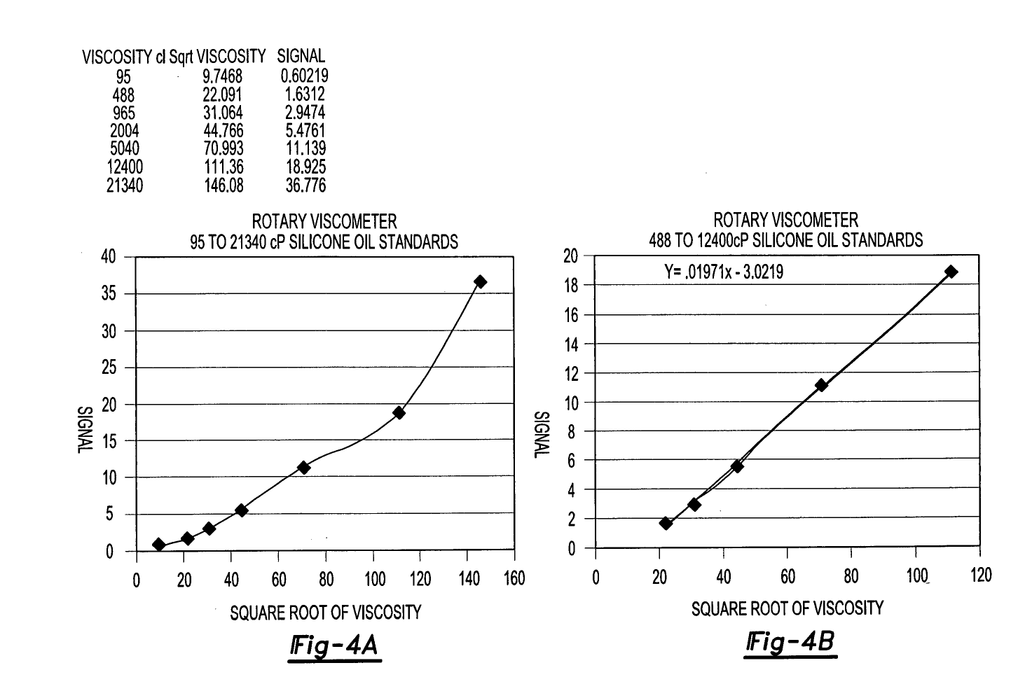

For exemplary purposes, FIGS. 4A and 4B are provided to graphically illustrate responses (i.e. signals) that were produced according to the present invention for silicone oils of variable viscosities. As can be seen, substantially linear relationships exist between the square roots of the viscosities of the oils and their responses.

In certain embodiments of the present invention, it may be desirable to monitor a parameter of the sample multiple times within a single sample. As one example, it may be desirable to monitor a parameter within a sample multiple times over a particular period of time to monitor real-time changes in the parameter or to monitor changes in a rheological property of the sample related to the parameter. As another example, it may be desirable to monitor a parameter within the sample at multiple locations within the sample to determine differences in the parameter or to determine differences in a rheological property of the sample related to the parameter at the multiple locations. Moreover, multiple measurements at multiple locations may be taken over a particular time period.

Thus, in one embodiment, it is contemplated that a parameter (e.g., a parameter that relates to a rheological property) of a sample is measured at a first time followed by measuring the parameter at a second time and so on during a predetermined period of time. Typically, although not required, one or more processes are occurring during the predetermined period of time and the one or more processes can affect (e.g., change) the parameter and/or the rheological property of the sample. Of course, it is contemplated that monitoring may be performed to determine if a particular process has any effect at all on a sample such that the parameter or rheology of a sample may not change over the period of time.

Exemplary processes that occur within or about the sample and may affect the parameters or rheological properties of the sample over time include, without limitation, evaporation of a portion of the sample, condensation of a portion of the sample, chemical reaction within the sample, dilution of the sample, chemical addition to the sample, composition changes of a sample, combinations thereof or the like. Generally, it should be understood that, for a plurality or library of samples as opposed to a single sample, monitoring of each sample of the plurality may be accomplished serially or in parallel according to the methodologies of the present invention and using the apparatus of the present invention as previously described.

According to another embodiment, it is contemplated that a parameter (e.g., a parameter that relates to a rheological property) of a sample is measured at a first location with the sample followed by measuring the parameter at a second location in the sample and so on wherein the second location is different from the first location. In such an embodiment, there may be a process occurring or a process may have already occurred, which causes the parameter and/or the rheological property of the sample to be different at the different locations within the sample. Of course, it is contemplated that monitoring may be performed to determine if a particular process is occurring or has occurred at all to a sample such that the parameter or rheology of a sample may be internally different or may be the internally homogeneous.

Exemplary processes, which can cause a sample to have an internally varying parameter or rheological property include, without limitation, phase separation within a sample, mixing (e.g., stirring) of a sample, precipitation within a sample, gravitational effects on a sample, combinations thereof or the like. As with the previous embodiment, it should be understood that, for a plurality or library of samples as opposed to a single sample, monitoring of the samples may be accomplished serially or in parallel according to the methodologies of the present invention and using the apparatus of the present invention as previously described.

In alternative embodiments, the system may be employed for measuring density. In such an embodiment, the system is first calibrated in a reference fluid (e.g., air) by moving the probe at constant angular amplitude at several frequencies or sweeping the frequency within a certain range and recording the energy or power (e.g., electrical current) required to do so. It can be observed that the current waveform is typically sinusoidal and it typically exhibits some phase shift with respect to the angle waveform and also its amplitude typically increase with the increasing frequency.

As an example, the current waveform can be considered as having two components—one running at 90 degrees phase shift with respect to the angle waveform and the second one running at 180 degrees shift. In the example, the first component represents the loss in the actuator and the second one represents the combined inertia of the rotor, the shaft and the attached probe. At usual operation frequencies in the reference fluid, the first component is negligibly small compared to the second one. Thus, since, inertial response is typcially proportional to the frequency squared, use of several frequency points or a sweep allows calculation of the combined moment of inertia for the actuator and the probe together.

When the probe is placed in a liquid under test and the procedure described above is repeated and the energy or power (e.g,, current) required to keep the constant angle will be higher. For relatively low viscosity liquids the first (90 degree) component will be higher than in the air but still much smaller than the second one (180 degree). The frequency dependence of the current's second component will, thus typically rise faster with the frequency such that the additional inertia produced by the liquid can be calculated using the approach described above. This additional inertia is usually referred to as an “added mass” or a “virtual mass” and is often directly proportional to the density of the liquid under test. Thus, a proportionality coefficient, which will typically depend substantially only on the geometry of the probe and the geometry of the measurement volume can be calculated. This coefficient, once calibrated, using a fluid of known density or a set of such fluids can be used to calculate viscosity of unknown fluids. In one particular embodiment, the probe can be placed into the unknown liquid, the additional inertia can be measured and the density can be found by dividing the additional inertia by the geometry coefficient.

It shall be appreciated that the present invention provides a variety of advantages over previous systems and methods. As an example, material samples may be screened while they remain in wells of one or more substrates or vessels. As another example, responses of samples to the motion of the probes can be gathered and interpreted at a rapid pace as further discussed below.

Sample-Throughput

For methods directed to characterizing a plurality of samples, a property of each of the samples or of one or more components thereof is detected—serially or in a parallel, serial-parallel or hybrid parallel-serial manner—at an average sample throughput of not more than about 10 minutes per sample, though slower throughput is within the present invention. As used in connection herewith, the term “average sample throughput” refers to the sample-number normalized total (cumulative) period of time required to detect a property of two or more polymer samples with a characterization system. The total, cumulative time period is delineated from the initiation of the characterization process for the first sample, to the detection of a property of the last sample or of a component thereof, and includes any intervening between-sample pauses in the process. The sample throughput may be not more than about 8 minutes per sample, not more than about 4 minutes per sample, not more than about 2 minutes per sample and even as low as about 15 to 30 seconds per sample. Depending on the quality resolution of the characterizing information required, the average sample throughput can be not more than about 1 minute per sample, and if desired, not more than about 30 seconds per sample, not more than about 20 seconds per sample or not more than about 10 seconds per sample, and in some applications, not more than about 5 seconds per sample and not more than about 1 second per sample. Sample-throughput values of less than 4 minutes, less than 2 minutes, less than 1 minute, less than 30 seconds, less than 20 seconds and less than 10 seconds are demonstrated in the examples. The average sample-throughput can range from about 10 minutes per sample to about 10 seconds per sample, from about 8 minutes per sample to about 10 seconds per sample, from about 4 minutes per sample to about 10 seconds per sample and, in some applications, from about 2 minutes per sample to about 10 seconds per sample.

A sample-throughput of 10 minutes per sample or less is important for a number of reasons. Systems that detect a property of a sample or of a component thereof at the aforementioned sample throughput rates can be employed effectively in a combinatorial research program. From a completely practical point of view, the characterization rates are also roughly commensurate with reasonably-scaled sample library synthesis rates. It is generally desirable that combinatorial screening systems, such as the characterization protocols disclosed herein, operate with roughly the same sample throughput as combinatorial synthesis protocols—to prevent a backlog of uncharacterized product samples. Hence, to illustrate, because moderate scale polymer-synthesis systems, such as the Discovery ToolS™ PPR-48™ (Symyx Technologies, Santa Clara Calif.), can readily prepare polymer libraries with a sample-throughput of about 100 polymer samples per day, a screening throughput of about 10 minutes per sample or faster is desirable. Higher throughput synthesis systems demand higher characterization throughputs. The higher throughput values are also important with respect to process control applications, to provide near-real time control data.

Additionally, the characterization of samples at such throughputs can offer sufficiently rigorous quality of data, to be useful for scientifically meaningful exploration of the materials, compositions, formulations, compounds and/or reaction conditions.

Hence, the average sample-throughput can range from about 10 minutes per sample to about 8 minutes per sample, from about 8 minutes per sample to about 2 minutes per sample, from about 2 minutes per sample to about 1 minute per sample, from about 1 minute per sample to about 30 seconds per sample and from about 1 minute per sample to about 10 seconds per sample, with preferences depending on the quality of resolution required in a particular case. For example, in some research strategies, the very high sample throughputs can be effectively employed to efficiently screen a sample or component thereof having a particularly desired property (e.g., such as weight-average molecular weight). In short, the search can be accelerated for the particular property of research interest.

In other embodiments, viscosity can be measured at an average sample-throughput of not more than 60 minutes per library, not more than 10 minutes per library, and even not more than 2 minutes per library. In still other embodiment, the viscosity can be measured at an average sample-throughput of not more than 60 seconds per library, not more than 30 seconds per library, and even not more than 10 seconds per library. Calibration Methods and Standards

As desired the systems and methods of the present invention may optionally employ a calibration procedure. By way of example, a calibration standard is provided having a number of subcomponents that differ with respect to viscosity. Such subcomponents are typically referred to as “known standards” or, simply, “standards” that are well characterized with respect to the calibrating property of interest. They are analyzed by the viscosity measuring apparatus of the present invention and the apparatus is adjusted as desired.

Other Screens

The present invention may be employed by itself or in combination with one or more other screening protocols (e.g., using the same instrument with an interchangeable test fixture, or a different instrument) for the analysis of polymers, liquids or their constituents. Without limitation, examples of such screening techniques include those addressed or identified in commonly-owned U.S. Pat. No. 6,182,499 (McFarland et al); U.S. Pat. No. 6,175,409 B1 (Nielsen et al); U.S. Pat. No. 6,157,449 (Hajduk et al); U.S. Pat. No. 6,151,123 (Nielsen); U.S. Pat. No. 6,034,775 (McFarland et al); U.S. Pat. No. 5,959,297 (Weinberg et al), U.S. Pat. No. 5,776,359 (Schultz et al.), all of which are hereby expressly incorporated by reference herein.

It should be understood that the invention is not limited to the exact embodiment or construction which has been illustrated and described but that various changes may be made without departing from the spirit and the scope of the invention.

What is claimed is:

1. A method of screening a library of materials for a rheological property, the method comprising:
(a) providing a library of material samples supported in wells or on the surface of one or more substrates;
(b) at least partially contacting each sample of the library of samples with a contact portion of one or more probes;
(c) moving the contact portion of the one or more probes relative to the each sample of the library of samples;
(d) monitoring a parameter selected from power or force used to move the one or more probes or position amplitude, phase or position time dependence of the one or more probes during the moving of the contact portion of the one or more probes; and
(e) relating the parameter to a rheological property of the each sample of the library of samples.

2. A method as in claim 1 wherein the parameter is phase and amplitude of the one or more probes.

3. A method as in claim 1 wherein the parameter is phase or amplitude of the one or more probes at a constant force or power.

4. A method as in claim 1 further comprising analyzing the library of samples by comparing the rheological property of each of the samples to a desired value.

5. A method as in claim 1 wherein the rheological property is viscosity.

6. A method as in claim 1 wherein the one or more probes include a plurality of disposable probes.

7. A method as in claim 1 wherein the contact portion of the one or more probes includes a plurality of contact surfaces that are substantially planar relative to an axis of rotation of the probe.

8. A method as in claim 7 wherein the contact portion of the one or more probes is substantially disc-shaped.

9. A method as in claim 1 wherein moving the contact portion includes rotating the probe in an oscillatory manner or moving the probe according to a predetermined motion.

10. A method as in claim 1 wherein the monitoring step
includes monitoring the power or force required to maintain a specific angular amplitude of the probe over time during the rotating of the probe.

11. A method as in claim 10 wherein the predetermined motion is a rotation of a predetermined number of degrees.

12. A method as in claim 1 wherein the force is torque used to move the one or more probes, rate of rotation of the probe or a combination thereof

13. A method as in claim 1 wherein the moving of the contact portion of the one or more probes is at least partially induced by a waveform generator.

14. A method as in claim 1 wherein the moving of the contact portion of the one or more probes is at least partially induced with a servo motor.

15. A method as in claim 1 wherein the library of samples include polymeric materials.

16. A method as in claim 1 wherein the library of samples include food formulations.

17. A method as in claim 1 wherein the library of samples include personal care formulations.

18. A method as in claim 1 wherein the library of samples include coating formulations.

19. A method as in claim 1 wherein the library of samples include rubber sheet or sample of predetermined shape.

20. A method as in claim 1 wherein the parameter for a first sample of the library of samples is monitored simultaneously with the monitoring of the parameter for a second sample of the library of samples.

21. A method as in claim 1 wherein the parameter for a first sample of the library of sample is monitored serially relative to the monitoring of the parameter for a second sample of the library of samples.

22. A method as in claim 1 wherein the step of providing the library of samples includes dispensing the library of samples with an automated system and elevating the temperature of the samples using the substrate.

23. A method as in claim 1 wherein the step of monitoring the parameter is accomplished at a rate of no greater than about 10 minutes per sample.

24. A method as in claim I wherein the monitoring step includes monitoring the parameter at multiple times over a particular period of time for determining changes to the rheological property over the particular period of time.

25. A method as in claim 1 wherein the monitoring step includes monitoring the parameter at multiple different locations within each of the sample of the plurality of samples.

26. A method of screening a library of materials for a rheological property, the method comprising:
(a) providing a library of at least 16 material samples supported in wells or on the surface of a substrate;
(b) at least partially contacting each sample of the library of samples with a contact portion of one or more probes;
(c) rotating the contact portion of the one or more probes in an oscillatory manner relative to the each sample of the library of samples according to electrical signals produced by a waveform generator;
(d) monitoring a parameter selected from power or force used to rotate the one or more probes or position, amplitude or position time dependence of the one or more probes during the rotating of the contact portion of the one or more probes; and
(e) relating the parameter to a rheological property of the each sample of the library of samples.

27. A method as in claim 26 further comprising analyzing the library of samples by comparing the rheological property of each of the samples to a desired value.

28. A method as in claim 26 wherein the rheological property is viscosity.

29. A method as in claim 26 wherein the one or more probes includes a plurality of disposable probes.

30. A method as in claim 26 wherein the contact portion of the one or more probes includes a plurality of contact surfaces that are substantially planar relative to an axis of rotation of the probe.

31. A method as in claim 30 wherein the contact portion of the one or more probes is substantially disc-shaped.

32. A method as in claim 26 wherein the rotating of the contact portion of the one or more probes is at least partially induced by a servo motor.

33. A method as in claim 26 wherein the signal from the waveform generator is selected from a sine wave electrical signal or a cosine wave electrical signal.

34. A method as in claim 26 wherein the step of rotating the contact portion includes employing circuitry for producing a predetermined rate of rotation.

35. A method as in claim 34 wherein the circuitry includes a lock-in amplifier.

36. A method as in claim 26 wherein the library of samples include polymeric materials.

37. A method as in claim 26 wherein the parameter for a first sample of the library of samples is monitored simultaneously with the monitoring of the parameter for a second sample of the library of samples.

38. A method as in claim 26 wherein the parameter for a first sample of the library of sample is monitored serially relative to the monitoring of the parameter for a second sample of the library of samples.

39. A method as in claim 26 wherein the step of providing the library of samples includes dispensing the library of samples with an automated system and elevating the temperature of the samples using the substrate.

40. A method as in claim 26 wherein the step of monitoring the parameter is accomplished at a rate of no greater than about 10 minutes per sample.

41. A method of screening a library of materials for rheological property, the method comprising:
(a) providing a library of at least 16 material samples supported in wells or on the surface of a substrate;
(b) at least partially contacting each sample of the library of samples with a contact portion of one or more probes wherein:
i) one or more actuators are attached to an automated system and at least selectively attached to the one or more probes; and
ii) the automated system moves the one or more actuators and the one or more probes for contacting the each sample of the library of samples with the contact portion of the one or more probes;
(c) rotating the contact portion of the one or more probes in an oscillatory manner relative to the each sample of the library of samples with the one or more actuators, wherein:
i) the contact portion of the one or more probes is rotated according to electrical signals produced by a waveform generator that is at least selectively in electrical communication with the one or more actuators;
(d) monitoring a parameter selected from power or force used to rotate or oscillate the one or more probes or position, amplitude, phase or position time dependence of the one or more probes during the rotating and oscillating of the contact portion of the one or more probes; and
(e) relating the parameter to a rheological property of the each sample of the library of samples.

42. A method as in claim 41 wherein the rheological property is viscosity.

43. A method as in claim 41, wherein the waveform generator is at least selectively in electrical communication with a motor of each of the one or more actuators.

44. A method as in claim 41 wherein the rotating of the contact portion of the one or more probes is at least partially induced by a servo motor.

45. A method as in claim 41 wherein the one or more probes includes a plurality of disposable probes.

46. A method of screening a material for a rheological property, the method comprising:
(a) providing a sample supported in a well or on the surface of a substrate;
(b) at least partially contacting the sample with a contact portion of one or more probes;
(c) rotating the contact portion of the one or more probes in an oscillatory manner relative to the sample according to electrical signals produced by a waveform generator;
(d) monitoring a parameter selected from torque used to rotate the one or more probes or rate of rotation or angle of rotation as a function of time of the one or more probes during the rotating of the contact portion of the one or more probes;
(e) relating the parameter to a rheological property of the sample.

47. A method as in claim 46 further comprising analyzing the sample by comparing the rheological property of the sample to a desired value.

48. A method as in claim 46 wherein the rheological property is viscosity.

49. A method as in claim 46 wherein the contact portion of the one or more probes includes a plurality of contact surfaces that are substantially planar relative to an axis of rotation of the probe.

50. A method as in claim 46 wherein the contact portion of the one or more probes is substantially disc-shaped.

51. A method as in claim 46 wherein the rotating of the contact portion of the one or more probes is at least partially induced by a servo motor.

52. A method as in claim 46 wherein the signal from the waveform generator is selected from a sine wave electrical signal or a cosine wave electrical signal.

53. A method as in claim 46 wherein the step of rotating the contact portion includes employing circuitry for producing a predetermined rate of rotation.

54. A method as in claim 53 wherein the circuitry includes a lock-in amplifier.

55. A method as in claim 46 wherein the sample is polymeric.

56. A method as in claim 46 wherein the monitoring step includes monitoring the parameter at multiple times over a particular period of time for determining changes to the rheological property over the particular period of time.

57. A method as in claim 46 wherein the monitoring step includes monitoring the parameter at multiple different locations within the sample to determine internal differences in rheology of the sample.

58. A system for screening a library of materials for a rheological property, the system comprising:
a plurality of samples supported in wells or on a surface of a substrate, the plurality of samples being fluidic;
one or more probes, each of the one or more probes including a contact portion for at least partially contacting the plurality of samples;
an actuator for rotating the contact portion of the one or more probes in an oscillatory manner relative to the plurality of samples;
a transducer for sensing a parameter selected from torque used to rotate the one or more probes or rate of rotation of the one or more probes wherein the parameter can be related to the rheological property of the plurality of samples; and
an automated system for moving the one or more probes relative to the plurality of samples.

59. A system as in claim 58 further comprising a computer sub-system for relating the parameter to a rheological property of the sample.

60. A system as in claim 58 further comprising a waveform generator and a lock-in amplifier in communication with the actuator wherein the waveform generator and the lock-in amplifier cooperatively produce an electrical signal, which assists in controlling the rotation of the contact portion of the one or more probes.

61. A system as in claim 58 wherein the automated system includes an X-Y-Z robot arm.

62. A system as in claim 58 wherein the one or more probes are formed of a plastic material.

63. A system as in claim 58 wherein the contact portion of the one or more probes includes a plurality of contact surfaces that are substantially planar relative to an axis of rotation of the probe.

64. A system as in claim 63 wherein the contact portion of the one or more probes is substantially disc-shaped.

65. A system as in claim 58 wherein the actuator rotates the one or more probes with power provided by a servo motor.

66. A system as in claim 58 wherein the actuator includes a fastener for selectively attaching to the one or more probes and wherein the one or more probes are disposable.

67. A system as in claim 58 wherein the transducer is a motion sensor that senses angles of rotation of the one or more probes.
